(19) United States
(12) Patent Application Publication
(10) Pub. No.: US 2012/0066162 A1
(43) Pub. Date: Mar. 15, 2012

(54) System and Method for Training an Adaptive Filter in an Alternate Domain with Constraints

(75) Inventors: Milind Anil Borkar, Dallas, TX (US); Fernando Alberto Mujica, Allen, TX (US)

(73) Assignee: TEXAS INSTRUMENTS INCORPORATED, Dallas, TX (US)

(21) Appl. No.: 12/878,817

(22) Filed: Sep. 9, 2010

(51) Int. Cl. G06F 15/18; G06F 17/14; G06F 17/10

(52) U.S. Cl. 706/13; 708/322; 708/405; 706/14

(57) ABSTRACT

The adaptive filtering techniques described herein allow a filter that is operating in a target domain to be trained in another domain, possibly with constraints, using the same adaptation framework used in a standard adaptive filter. As a result, the adaptation engine may be configured to run in a transform domain that is more desirable than the target domain. For example, the transform domain may be less susceptible to noise or may have more impact on the trained filter's desired results. The filter is trained in the transform domain and then the filter hardware is updated in the target domain.

### TECHNICAL FIELD

Embodiments of the invention are directed, in general, to training adaptive filters and, more specifically, to training an adaptive filter in one domain and then implementing the filter in another domain.

### BACKGROUND

In known systems, signals are filtered in the domain that corresponds to desired filter characteristics. For example, to filter a signal in the frequency domain, the signal must already be in the frequency domain, or it must be transformed to the frequency domain prior to filtering. After filtering, the modified signal may then be transformed to another domain or back to an original domain. Prior art systems related to adaptation of transform domain filters are always implemented in the transform domain. The signal being processed must first be converted from the original domain to the transform domain and then filtered in the transform domain.

Existing techniques for transform domain adaptation use one of the following methods: (1) implement the filter in the transform domain so that the filter and the adaptation are both implemented in the same domain, or (2) use a separate estimation algorithm to generate the desired filter response in the transform domain and use filter design techniques to generate the desired target domain filter. These techniques are not optimal because they either require transformation of the filtered signal, which might not be possible if the filter hardware already exists in the target domain, or are difficult to implement using an adaptive framework, especially if the filter is nonlinear.

### SUMMARY

Embodiments of the invention run the adaptation algorithm in a transform domain but implement the filter in an original domain. This eliminates the need for the processed signal to undergo a transformation between domains, thereby eliminating the need to redesign existing hardware. Embodiments also allow a user to apply constraints in the transform domain even if the filter is implemented in the original domain. The adaptive filters described herein do not require the filter and the adaptation to be implemented in the same domain.

The adaptive filtering techniques described herein allow a filter that is operating in a target domain to be trained in another domain, possibly with constraints, using the same adaptation framework used in a standard adaptive filter. As a result, the adaptation engine may be configured to run in a transform domain that is more desirable than the target domain. For example, the transform domain may be less susceptible to noise or may have more impact on the trained filter's desired results. The filter is trained in the transform domain and then the filter hardware is updated in the target domain.

### BRIEF DESCRIPTION OF THE DRAWINGS

Having thus described the invention in general terms, reference will now be made to the accompanying drawings, wherein:

FIG. 1 is a block diagram for an adaptive filter according to one embodiment;

FIG. 2 is a block diagram of a FIR filter;

FIG. 3 illustrates desired transform domain coefficients for a FIR filter;

FIG. 4 illustrates an exemplary trained filter comprising FIR filter hardware and transform adaptation software; and

FIG. 5 is a flow diagram illustrating a process for updating an adaptive filter according to one embodiment.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

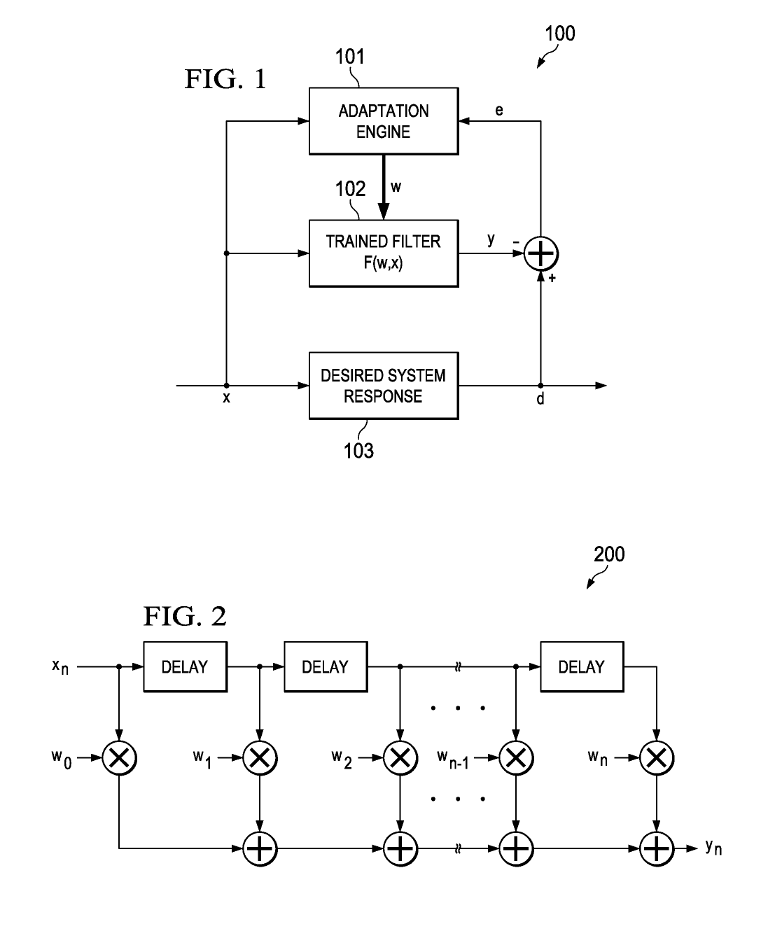

FIG. 1 illustrates a block diagram for an adaptive filter 100. Adaptation engine 101 observes input signal x and error signal e, which represents the difference between d, the output of the desired system 103, and y, the output of trained filter 102. Adaptation engine 101 derives complex filter coefficients w that minimize the error signal e—i.e. train F(w,x) so that e is reduced or minimized. Typically, in a Least Mean Squares (LMS) adaptive filter, for example, the adaptation engine 101 generates coefficients w that minimize the mean square error.

Adaptation engine 101 could use the steepest descent method to find filter weights w that minimize a cost function, which may be defined function as:

C(n)=|e(n)|²=e* (n)·e(n) Eq. 1

where e(n) is the error at the current sample n:

e(n)=d(n)−y(n) Eq. 2

Applying the LMS algorithm, the update equation for standard adaptive filtering is given by:

wₙ₊₁=wₙ−μ∇_{w*}_{ₙ}C(n) Eq. 3

where μ is the step size, ∇ is the gradient operator, and ∇_{w*}_{ₙ}C (n) is a vector pointing toward the steepest ascent of cost function C (n) . Incorporating Equations 1 and 2 into Equation 3 results in the following equations:

wₙ₊₁=wₙ−μe(n)∇_{w*}_{ₙ}(d*(n)−y*(n)) Eq. 4

wₙ₊₁=wₙ+μe(n)∇_{w*}_{ₙ}F(w*ₙ, x*ₙ) Eq. 5

where xₙ, represents the input vector that is used to generate y(n).

For the special case in which F(w, x) is associated with a linear Finite Impulse Response (FIR) filter, Equation 5 can be further simplified as:

wₙ₊₁=wₙ+μe(n)∇w*_{ₙ}wₙ^{H}x*ₙ Eq. 6

wₙ₊₁=wₙ+μe(n)x*ₙ Eq. 7

Returning to Equation 5, assume w consists of K coefficients

w(k), k=1, . . . , K Eq. 8

If desired, it is possible to train only a subset of the coefficients by using an adaptation mask.

k⊂K, K={1, . . . , K} Eq. 9

k∈k Eq. 10

w(k)ₙ₊₁=w(k)ₙ+μe(n)∇_{w*}_{ₙ}(k)F(w*ₙx*ₙ) Eq. 11

For the FIR case, the k^{th} coefficient can be trained as

w(k)ₙ₊₁=w(k)ₙ+μe(n)∇_{w*}_{ₙ}(k)wₙ^{H}x*ₙ Eq. 12

w(k)ₙ₊₁=w(k)ₙ+μe(n)x*ₙ(k) Eq. 13

In a transform domain adaptation, the coefficients w of the trained filter 102, which are implemented in one domain, are trained in an alternate domain, possibly with constraints, using the same adaptation framework used by a standard adaptive filter as shown above. The domain of the coefficients w is the target domain, and the domain in which adaptation occurs is the transform domain. Assume H is the transform from the target domain to the transform domain, and H⁻¹ is the inverse transformation. Let b represent the coefficients in the transform domain being trained by the adaptation engine. Then, the coefficients b in the transform domain are related to the coefficients w in the target domain as follows:

b=H(w) Eq. 14

The coefficient update equations (Equations 3-5) can be rewritten in the transform domain as:

bₙ₊₁=bₙ−μ∇_{b*}_{ₙ}C(n) Eq. 15

bₙ₊₁=bₙ−μe(n)∇_{b*}_{ₙ}(d*(n)−y*(n)) Eq. 16

bₙ₊₁=bₙ+μe(n)∇_{b*}_{ₙ}F(w*ₙ, x*ₙ) Eq. 17

Substituting transform domain coefficients b for the remaining target domain coefficients w results in the following equation:

bₙ₊₁=bₙ+μe(n)∇_{b*}_{ₙ}F((H⁻¹(bₙ))* ,x*ₙ) Eq. 18

where the coefficients written to the filter are given by

w=H⁻¹(b) Eq. 19

Equation 18 applies to arbitrary filters, potentially nonlinear, and arbitrary domains, it may be simplified further by considering special cases. First, assume that the target domain is the time domain, and the transform domain is the frequency domain. Using a Discrete Fourier Transform (DFT) matrix, represented by the transform operator D, Equation 18 can be simplified as:

bₙ₊₁=bₙ+μe(n)∇_{b*}_{ₙ}F((D^{H}bₙ)*, x*ₙ) Eq. 20

bₙ₊₁=bₙ+μe(n)∇_{b*}_{ₙ}F(D^{T}b*ₙ, x*ₙ) Eq. 21

For the special case in which F(w, x) is associated with a linear FIR filter, Equation 21 can be further simplified as:

bₙ₊₁=bₙ+μe(n)∇_{b*}_{ₙ}bₙ^{H}Dx*ₙ Eq. 22

bₙ₊₁=bₙ+μe(n)Dx*ₙ Eq. 23

Returning to Equation 18, assume b consists of M coefficients

b(m), m=1, . . . , M Eq. 24

If desired, it is possible to train only a subset of the coefficients by using an adaptation mask.

β⊂B, B={1, . . . , M} Eq. 25

m ∈β Eq. 26

bₙ₊₁(m)=bₙ(m)+μe(n)∇_{b*}_{ₙ}(m)F((H⁻¹(bₙ))*, x*ₙ) Eq. 27

For the special case of a FIR filter and DFT matrix D representing the transform operator from time domain (target domain) to frequency domain (transform domain), the m^{th} coefficient can be trained as

bₙ₊₁(m)=bₙ(m)+μe(n)∇_{b*}_{ₙ}(m)bₙ^{H}Dx*ₙ Eq. 28

bₙ₊₁(m)=bₙ(m)+μe(n)D(m,:)x*ₙ Eq. 29

Adaptation engine 101 generates trained coefficients b corresponding to a desired response in trained filter 102. Adaptation engine 101 then transforms the trained coefficients b to target domain coefficients w using the inverse transform given in Equation 19 and writes the target domain coefficients w back to trained filter 102.

For simplicity, the examples discussed herein describe a linear FIR filter wherein the target domain is the time domain and the transform domain is the frequency domain. However, this formulation can be extended to nonlinear problems in a variety of domains. For example, the results may be extended to other algorithms, such as Recursive Least Squares (RLS) filters, the Kalman filter, and the like. Applications include, for example, noise cancellation, system identification, digital predistortion of power amplifiers and other systems without limitation.

The transform domain adaptation process described herein offers various advantages over standard adaptation. For example, transform domain adaptation allows for constrained adaptation in the transform domain. In certain cases, although the filter is implemented in the target domain, constrained adaptation may be desired in the transform domain. For example, consider the case in which the input signal contains energy in a finite range of frequencies f₁. In this case, the error e is predominantly in the range of frequencies f₁. If adaptation is performed in the time domain, it would be difficult to constrain the filter's behavior and, because of numerical sensitivity issues, the trained filter's response could vary significantly at frequencies outside of f₁. In many cases, it might be desirable to train the filter such that its response is modified only in the regions where the signal is present. This could be accomplished by training the filter in the frequency domain, and only modifying those filter coefficients that correspond to the frequency bins within f₁ by using a coefficient mask as given in Equation 29.

After the filter converges, assume the energy in the signal moves to another range of frequencies f₂. Then the error will be predominantly in the range of frequencies f₂. If adaptation is performed in the time domain, it would be difficult to constrain the filter's behavior outside f₂ and the filter response in the range of frequencies f₁ could be disturbed, thereby modifying the previous training results for frequencies f₁. It is highly desirable to train the filter in the frequency domain, only modifying those filter coefficients that correspond to the frequency bins within f₂ and leave the filter response over f₁ unchanged by using an appropriate coefficient mask as given in Equation 29.

Embodiments of the novel adaptive filter technique disclosed herein—by which a filter implemented in a target domain is trained in a transform domain—are accomplished by:

1. Using knowledge available in the transform domain to determine which transform domain coefficients should be trained and which ones should not.

2. Using a coefficient mask in the transform domain to ensure only the desired transform domain coefficients are trained by the selected adaptation algorithm.

3. Exploiting the functional relationship between the filter error in the target domain and the coefficients to be trained in the transform domain to generate gradients, Hessians, linear approximations, and the like as required by the selected adaptation algorithm.

4. Applying the inverse transformation to the trained coefficients in the transform domain before updating the adaptive filter coefficients in the target domain.

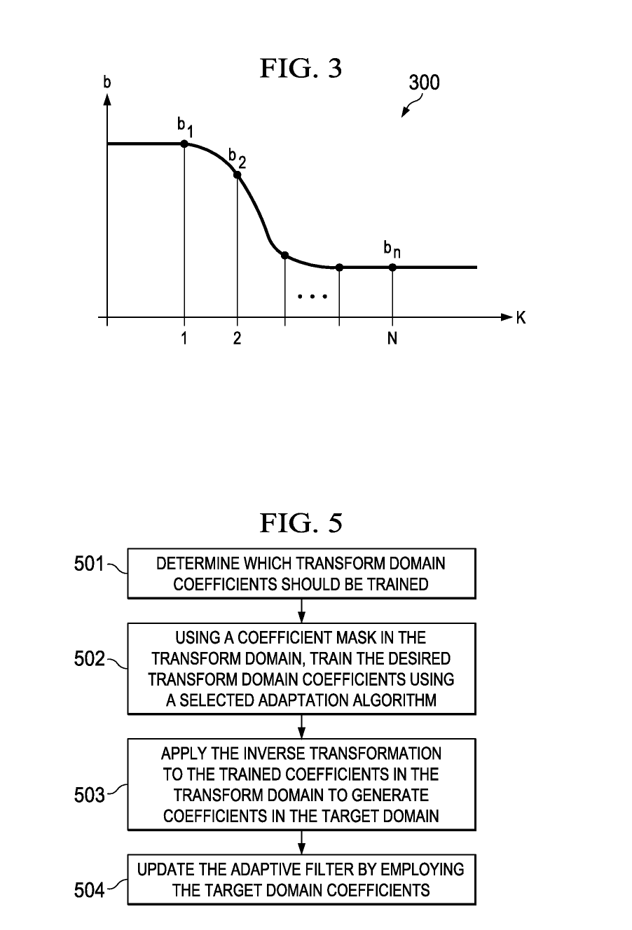

FIG. 2 is a block diagram of FIR filter 200 in which coefficients wᵢ are selected to achieve a desired shape in the transform domain. FIG. 3 illustrates desired transform domain coefficients bⱼ. A transform H can be calculated to define the relationship between coefficients wᵢ and coefficients bⱼ. A corresponding inverse transform H⁻¹ may be calculated to relate coefficients bⱼ to coefficients wᵢ. In one embodiment, coefficients bⱼ are trained using Equation 29. Then the inverse transform H⁻¹ is applied to coefficients bⱼ to generate coefficients wᵢ to be used in filter 200.

Changes in coefficients bⱼ can be immediately applied to filter 200 by generating coefficients wᵢ using inverse transform H⁻¹. Additionally, using a mask, specific coefficients in the transform domain can be trained without modifying others.

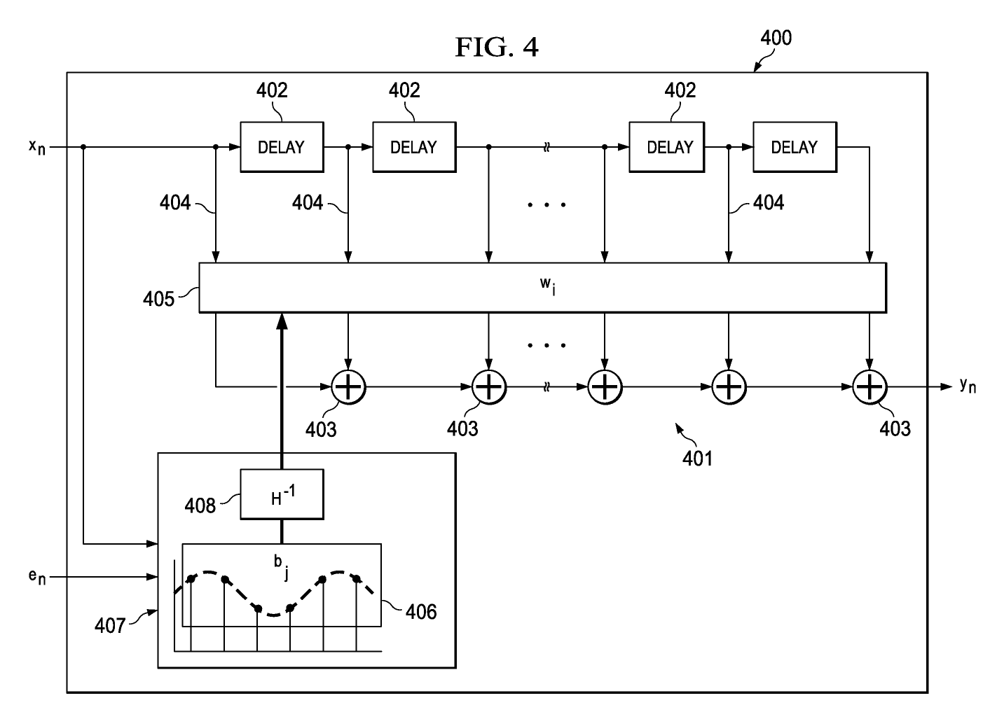

FIG. 4 illustrates an exemplary trained filter 400 comprising FIR filter hardware 401 and transform domain adaptation software. The signals tapped on each side of delay elements 402 are sequentially scaled and summed in elements 403 to generate output yₙ. Each tap 404 is modified by coefficient block 405. The value of the coefficients wᵢ applied to each tap 404 is selected based upon the inverse transform of transform domain coefficients bⱼ 406. Error signal eₙ and input xₙ are received in processor 407, which is running transform adaptation software or firmware. Processor 407 adjusts coefficients bⱼ 406, which are inverse transformed by software or firmware 408 to generate coefficients wᵢ that are used in coefficient block 405. Processor 407 continues to adjust coefficients bⱼ 406 indefinitely, or until error signal eₙ is zero or below a predetermined threshold, which indicates that the output y of trained filter 400 is within an acceptable range of a desired system response.

FIG. 5 is a flow diagram illustrating a process for updating an adaptive filter according to one embodiment. In step 501, the adaptive filter determines which transform domain coefficients should be trained. In step 502, using a coefficient mask in the transform domain, the adaptive filter trains the desired transform domain coefficients using a selected adaptation algorithm. In step 503, the adaptive filter applies an inverse transformation to the trained coefficients in the transform domain to generate coefficients in the target domain. In step 504, the adaptive filter employs the target domain coefficients generated in step 503.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. An adaptive filter, comprising:
a filter circuit comprising a plurality of weighted filter elements, each weighted filter element corresponding to a weighted coefficient in a target domain;
an adaptation engine comprising circuitry for generating weighted coefficients in a transform domain, the weighted coefficients in the transform domain selected to minimize an error signal input to the adaptation engine; and
a coefficient transform circuit receiving the weighted coefficients in the transform domain and converting the weighted coefficients in the transform domain to weighted coefficients in the target domain.

2. The adaptive filter of claim 1, wherein the target domain is a time domain, and the transform domain is a frequency domain.

3. The adaptive filter of claim 1, wherein the coefficient transform circuit uses an Inverse Discrete Fourier Transform (IDFT) matrix to convert the weighted coefficients in the transform domain to weighted coefficients in the target domain.

4. The adaptive filter of claim 1, wherein the circuitry for generating weighted coefficients in a transform domain further comprises:
mask circuitry for selecting a subset of transform coefficients to be trained.

5. The adaptive filter of claim 1, wherein the adaptation engine and the coefficient transform circuit comprise a processor running transform domain adaptation software.

6. A method for training an adaptive filter, comprising:
identifying transform domain coefficients to be trained;
applying a coefficient mask in the transform domain to ensure only selected transform domain coefficients are trained by a selected adaptation algorithm;
generating trained coefficients in the transform domain;
applying an inverse transformation to the trained coefficients in the transform domain to derive trained coefficients in a target domain; and
updating adaptive filter coefficients using the trained coefficients in a target domain.

7. The method of claim 6, wherein the target domain is a time domain, and the transform domain is a frequency domain.

8. The method of claim 6, wherein the adaptive filter is a Finite Impulse Response (FIR) filter.

9. The method of claim 8, wherein the trained coefficients in the target domain are applied to taps in the FIR filter.

10. The method of claim 6, wherein the inverse transform is an Inverse Discrete Fourier Transform (IDFT) matrix.

11. A method for training a Finite Impulse Response (FIR) filter, comprising:
identifying frequency domain coefficients to be trained;
generating trained coefficients in the frequency domain;
applying an inverse transformation to the trained coefficients in the frequency domain to derive trained coefficients in a time domain; and
updating adaptive filter coefficients using the trained coefficients in a time domain.

12. The method of claim 11, wherein the inverse transform is an Inverse Discrete Fourier Transform (IDFT) matrix.

13. The method of claim 11, further comprising:
applying a coefficient mask in the frequency domain to ensure only selected frequency domain coefficients are trained by a selected adaptation algorithm.

14. The method of claim 11, wherein updating adaptive filter coefficients using the trained coefficients in a time domain comprises:
modifying the tap weights in the FIR filter.
